(19) United States
(12) Patent Application Publication
(10) Pub. No.: US 2006/0085156 A1
(43) Pub. Date: Apr. 20, 2006

(54) Method and system for predicting memory leaks from unit testing

(76) Inventors: Adam K. Kolawa, Bradbury, CA (US); Roman S. Salvador, La Jolla, CA (US); Mathew David Love, San Diego, CA (US); Yaniv Inbar, San Diego, CA (US); Alex G. Kanevsky, Encinitas, CA (US)

Correspondence Address: CHRISTIE, PARKER & HALE, LLP, PO BOX 7068, PASADENA, CA, 91109-7068, US

(21) Appl. No.: 10/967,479

(22) Filed: Oct. 18, 2004

(51) Int. Cl. G06F 19/00

(52) U.S. Cl. 702/119

(57) ABSTRACT

A method for predicting memory leak in a computer program. The method includes acquiring a reference to a tested unit included in the computer program for preventing static data objects from being deallocated; repeatedly executing the tested unit for more than once; tracking which objects in the tested unit are allocated in a corresponding executing time; performing garbage collection; tracking which objects are deallocated during the garbage collection; comparing the object allocations to the object deallocations; and determining if every execution of the tested unit allocates memory that cannot be deallocated.

### FIELD OF THE INVENTION

The present invention relates to a method and system for testing computer programs. More specifically, the present invention is directed to a method and system for predicting memory leaks from unit testing.

### BACKGROUND OF THE INVENTION

When a dynamically allocated memory space is not properly deallocated, a memory leak takes place. As a result, the pointer or memory reference to the dynamically allocated memory space may not be reclaimed. Consequently, the allocable space of the total available memory will gradually diminish, causing the system to crash. Some programming languages include functions (for example Jvm in Java) to allocate memory from a “Java Heap” where the memory heap allocations and deallocations are hidden from the programmer. In this case, Java virtual machine (Jvm) executes the heap allocations when new objects, such as String XYZ=“XYZ”, are specified. Jvm uses the implied new constructor in this case, as it allocates the string “XYZ”. Jvm executes the deallocations when the program performs garbage collection and the object is no longer referenced. However, the programmer is usually not aware of the cost associated with the objects created and may not take care to eliminate references to objects that are not required because these allocations and deallocations are done by the Jvm. Nevertheless, memory leaks in JAVA also cause longer garbage collection times resulting in performance degradation.

There have been some suggested methods for improving the memory leak problem. However, they all lack the capability of predicting a memory leak situation without the memory leak occurring to a noticeable degree, during full program execution while under observation. Furthermore, none of the current solutions inherently distinguish between initialization memory allocation, memory caching, and bona fide memory leaks. The current methods typically let the user decide if allocated memory that cannot be garbage collected is indeed from a memory leak.

Therefore there is a need for a system and method for memory leak prediction in runtime execution environment that generates memory allocation and deallocation events by executing unit tests.

### SUMMARY OF THE INVENTION

In one embodiment, the invention is a method, or system for predicting memory leak in a computer program. The invention includes acquiring a reference to a tested unit included in the computer program for preventing static data objects from being deallocated; repeatedly executing the tested unit for more than once; tracking which objects in the tested unit are allocated in a corresponding executing time; performing garbage collection; tracking which objects are deallocated during the garbage collection; comparing the object allocations to the object deallocations; and determining if every execution of the tested unit allocates memory that cannot be deallocated.

### BRIEF DESCRIPTION OF THE DRAWINGS

FIG. 1A is an exemplary flow graph for test case generation from a java source code, according to one embodiment of the present invention;

FIG. 1B is an exemplary flow graph for the test engine 108 of FIG. 1A;

FIG. 2 is an exemplary process flow diagram, according to one embodiment of the present invention;

FIG. 3 depicts an exemplary process flow for executing a unit test, when memory leak detection is enabled, according to one embodiment of the present invention;

FIG. 4 shows an exemplary process for calculating repetitions based on a “test method entered” events, according to one embodiment of the present invention;

FIG. 4A shows an example for tracking object allocation and deallocation for an event;

FIG. 5 shows an exemplary process for creating “object allocation” and “object deallocation” records in a database, according to one embodiment of the present invention;

FIG. 6 illustrates an exemplary process for comparing objects allocated and deallocated as a result of executing a give test case, according to one embodiment of the invention;

FIG. 7 depicts an exemplary process for comparing objects allocated and deallocated as a result of executing a given tested method in all test cases created for that tested method, according to one embodiment of the invention;

FIGS. 8A and 8B are examples of memory leaks in a given pattern;

FIGS. 9A and 9B are examples of memory leaks in a given pattern;

FIG. 10 shows a combination of the exemplary patterns of FIGS. 8A and 9A;

FIG. 11 illustrates two exemplary scenarios for the exemplary pattern of FIG. 10;

FIG. 12 illustrates another exemplary scenario; and

FIG. 13 illustrates a top level view of an exemplary system for predicting memory leaks from unit testing, according to one embodiment of the present invention.

### DETAILED DESCRIPTION

Garbage collection (GC) is a system of automatic memory management which seeks to reclaim memory used by objects which will never be referenced in the future. The part of a system which performs garbage collection is typically called a garbage collector (gc).

The basic principle of how a garbage collector works is to determine what data objects in a program cannot be referenced in the future, and then reclaim the storage used by those objects. Although in general, it is impossible to know the moment an object has been used for the last time, garbage collectors use conservative estimates that allow them to identify when an object could not possibly be referenced in the future. For example, if there are no references to an object in the system, then it can never be referenced again.

While GC assists the management of memory, the feature is also almost always necessary in order to make a programming language type safe, because it prevents several classes of runtime errors. For example, it prevents “dangling pointer” errors, where a reference to a deallocated object is used.

Used mainly in object-oriented programming, the term method refers to a piece of code that is exclusively associated either with a class (called class methods or static methods) or with an object (called instance methods). Like a procedure in procedural programming languages, a method usually includes a sequence of statements to perform an action, a set of input parameters to parameterize those actions, and possibly an output value (called return value) of some kind. The purpose of methods is to provide a mechanism for accessing (for both reading and writing) the private data stored in an object or a class.

Functional testing (similar to black-box testing) is the process of verifying that a system or system component adheres to the specification that defines its requirements. Functional testing can be performed at the system level or the unit level. To perform functional testing, one typically creates a set of input/outcome relationships that verify whether each specification requirement is implemented correctly. At least one test case should be created for each entry in the specification document. Preferably, these test cases should test the various boundary conditions for each entry. After the test suite is ready, the test cases are executed and verified.

Unit testing involves testing software code at its smallest functional point, which is typically a single class. Each individual class should be tested in isolation before it is tested with other units or as part of a module or application. By testing every unit individually, most of the errors that might be introduced into the code over the course of a project can be detected or prevented entirely. The objective of unit testing is to test not only the functionality of the code, but also to ensure that the code is structurally sound and robust, and is able to respond appropriately in all conditions. Performing unit testing reduces the amount of work needs to be done at the application level, and drastically reduces the potential for errors. However, unit testing can be quite labor intensive if performed manually. The key to conducting effective unit testing is automatically generating test cases.

By performing unit testing, one can avoid the dangers that follow from delaying testing until the end of development. Because the most critical dynamic problems in application software (such as performance problems) are often the result of design or implementation flaws, fixing these problems frequently requires redesigning and/or rewriting the entire application software. However, if one tests each servlet, bean, or other type of program unit immediately after it is written (i.e., perform unit testing), critical flaws can be spotted and resolved before they become widespread. Essentially, many problems can be prevented that would be difficult and costly to fix. This translates to fewer errors that elude testing, fewer resources spent on testing and debugging, and faster time to market.

In one embodiment, the invention disclosed in U.S. Pat. No. 5,784,553, the contents of which are herein fully incorporated by reference, is a Java unit testing tool that tests any Java class or component. That disclosed invention reads the specification information built into a class, then automatically creates and executes test cases that check the functionality described in the specification.

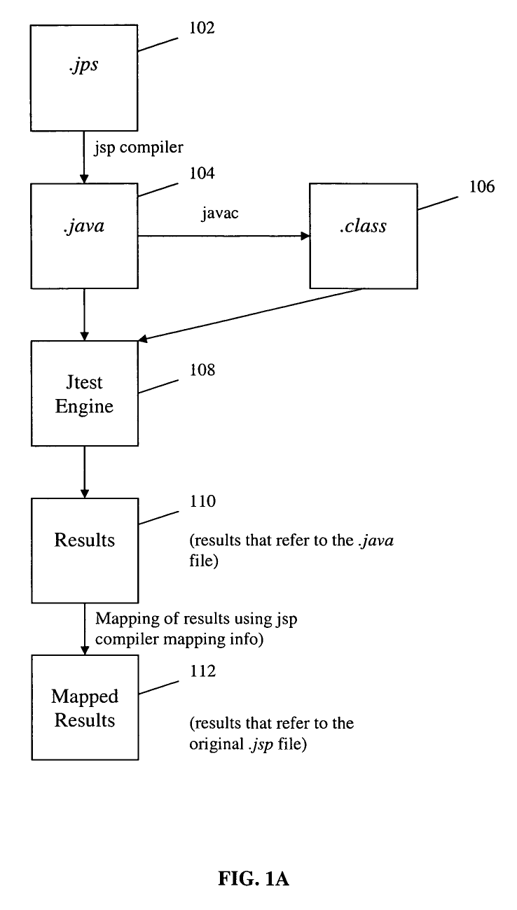

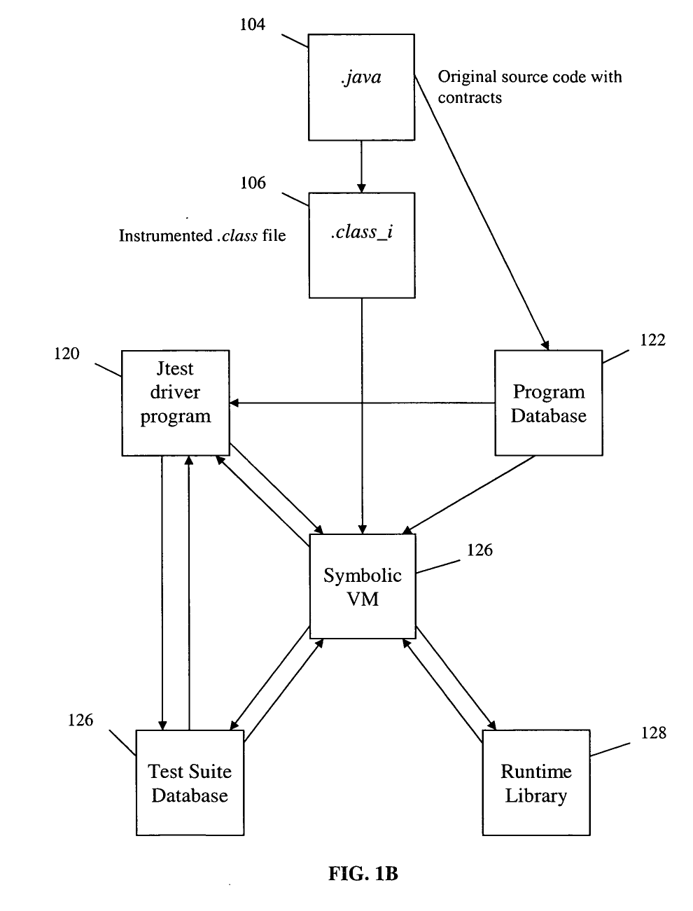

FIG. 1A is an exemplary flow graph for test case generation from a java source code. An original java file 104 is compiled into an instrumented .class_i file 106, typically, by using a DbC-java compiler. In addition to test case generation from a .java file, test cases can be generated from a java server pages (.jsp) file 102. The .java (or the .jsp) file along with the .class_i file is fed to a test engine 108. Test and verification results related to the java file are then obtained by Result 110. In case of a .jsp file, the results are mapped using .jsp compiler mapping results, as shown in block 112. Using the mapping information from the jsp compiler the results are mapped back to the .jsp file, so the error messages, etc. refer to the original .jsp file. From the user point of view, the intermediate .java and .class files are not visible. The user just sees a system that tests .jsp files.

FIG. 1B is an exemplary flow graph for the test engine 108 of FIG. 1A. Information about the contracts in the code (.java or .jsp file, and the .class_i file) is added to the program database 122. A driver program 120 invokes a symbolic virtual machine (VM) 124 to execute the program. The symbolic VM reads the instrumented .class_i file and any other .class files needed and executes the program symbolically. While executing the program, symbolic VM 120 decides what input to use on the fly. Basically, when arriving at a branch decision point in the program, symbolic VM looks in a test suite database 126 to find out what possible branch will generate a test case not in the test suite database, then it tries to find the appropriate input so that the desired branch is taken.

At the end of the program execution, the symbolic VM writes the selected input into the test suite database 126. The selected input contains the values for the arguments to the method being tested. The symbolic VM has the capability of changing on-the-fly the inputs it is using to run the test cases. The symbolic VM uses the information in the contracts that exist in the instrumented class file. The symbolic VM generates inputs to cover the different conditions that the DbC contracts specify. By generating inputs that cover the conditions in the @pre contract, only test cases that are valid are generated. By trying to generate inputs that cover the conditions in the @post, @invariant, @assert and in @pre conditions of called methods, the symbolic VM checks that the method follows the specification. For example, if the symbolic VM can find an input that makes a @post fail, it means that the method doesn't follow its DbC specification.

At this point, the driver program invokes the symbolic VM again. This process is repeated until the symbolic VM cannot find any more inputs. The runtime library 128 contains support code for the automatic stubs, the symbolic execution and the additional instrumented code generated by the invention. Stubs are basically replacements for references to methods external to the class.

In one embodiment, the present invention is a method and system for memory leak prediction in runtime execution environment that generates memory allocation and deallocation events by executing unit tests. The method and system of the present invention includes garbage collection functionality. The functionality that is natively supported by the runtime environment includes
Automatic garbage collection,
A method to force automatic garbage collection. Conversely, a method to ensure that gc happens by a particular point of the program execution, and
Ability to report memory deallocation events.

Other functionalities of runtime environment may be either natively supported by the environment, or introduced by the invention. An example of such other functionalities includes reporting memory allocation events. Most target runtime systems support it natively, however, in absence of native support this can be achieve by instrumenting either source code or binary object code of the unit test.

An instance of such runtime environment is a virtual machine (VM). For simplicity reasons, most examples for describing the method and system of the present invention are given in VM environment, the method and system of the present invention is not limited to such environment. Other environments such as, IBM™ Java VM, Oberon™ interpreter, C# interpreter™, compiled code written in any language that satisfies the above condition, are also within the scope of the present invention.

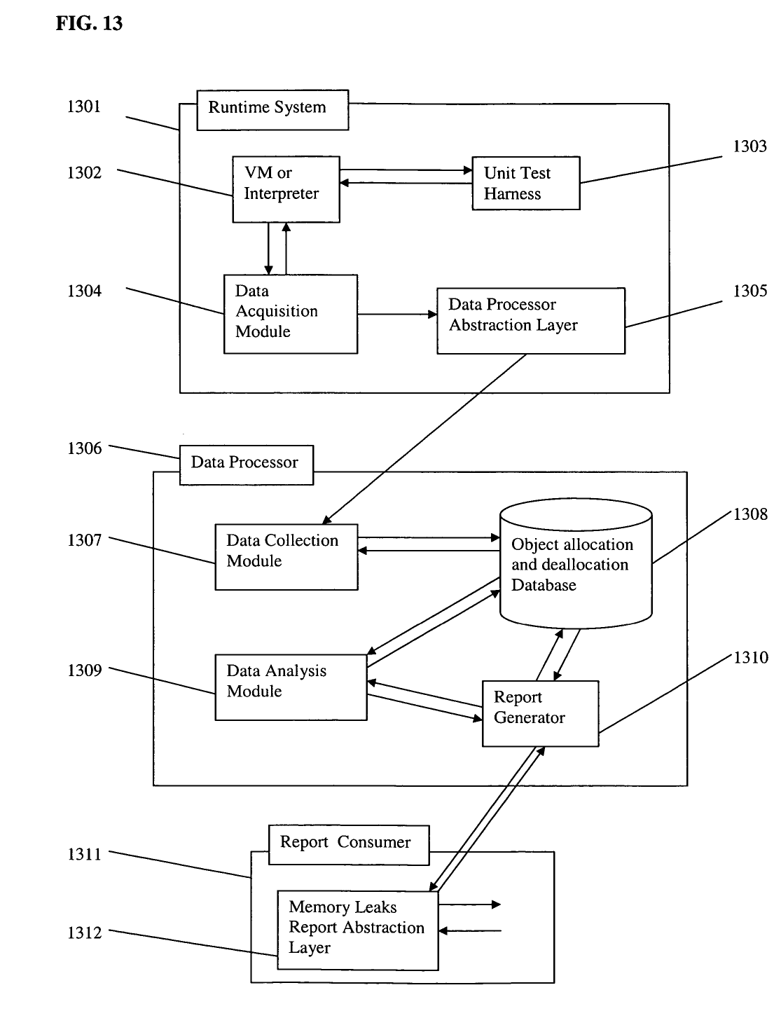

FIG. 13 illustrates a top level view of an exemplary system for predicting memory leaks from unit testing, according to one embodiment of the present invention. The system includes three top level components, Runtime System 1301, Data Processor 1306, and Report Consumer 1311. Runtime System 1301 is responsible for executing unit tests, collecting relevant data and sending that data to Data Processor 1306 in runtime system-independent format.

Runtime System 1301 includes a VM or Interpreter 1302 that supports automatic garbage collection; a Unit Test Harness 1303, which is a program module or a stand-alone program responsible for setting up and adjusting test environment, exercising test cases, and collecting, processing, and reporting results to other programs and/or program modules; and a Data Acquisition Module 1304 responsible for acquiring data necessary for memory leak detection from runtime execution environment and passing it over to Data Processor Abstraction Layer. In the case of a VM configuration, this module is responsible for enabling and disabling various VM debugger and profiler interface events, and/or instrumented statements in the unit tests, and passing this information to Data Processor Abstraction Layer 1305. Data Processor Abstraction Layer 1305 is a program module(s) responsible for extracting information from runtime environment (e.g., specific events), recording this information into runtime environment-independent data structures (events), and sending them to the Data Processor 1306, described below. For example, a format of the “method entered” event varies widely depending on internal implementation of a particular VM or an interpreter it was generated by. Data Processor Abstraction Layer extracts information useful for the Data Processor 1306 in a platform-dependent way, and sends it to Data Processor using a platform-independent data structure.

Data Processor 1306 is responsible for recording data that is provided by the runtime system to the database, interpreting flow control events, analyzing and interpreting the data, and reporting it to Report Consumer on demand. Data is reported in platform-independent way. Data Processor may be implemented as a module running on the same VM as a runtime system, or it may be running within a different application, or on a different computer than runtime system.

In one embodiment, Data Processor 1306 includes a Data Collection Module 1307, an object allocation and deallocation database 1308, a Data Analysis Module 1309, and a Report Generator 1310. Data Collection Module 1307 is responsible for transcribing Data Acquisition Module events and for storing them in the database. Object allocation and deallocation database 1308 contains information pertinent to objects allocation and deallocation as well as information on execution context in which those allocation/deallocation events transpired. Data Analysis Module 1309 retrieves information from the database 1308, analyzes and interprets the data, and sends the results to the Report Generator 1310. Report Generator requests Data Analysis Module to perform specific types of analysis, receives and formats the results, links the results to optional information from the database (e.g., stack traces and source code line numbers at which memory allocation happened, etc.), and sends the resulting report to the Memory Leaks Report Abstraction Layer 1312, or Report Consumer 1311.

Report Consumer 1311 requests, receives, and makes use of reports from Data Processor 1306. Data Processor may be implemented as a subsystem of the Report Consumer or vice versa. Report Consumer 1311 includes a Memory Leaks Report Abstraction Layer 1312 for allowing the Report Consumer to request and receive memory leaks reports. Memory Leaks Report Abstraction Layer 1312 also allows Report Consumer to access data in the report in implementation-independent way.

Typically, Design by Contract (DbC) is defined as a formal way of using comments to incorporate specification information into the code itself. DbC was design to create a contract between a piece of code and its caller. This contract specifies what the callee expects and what the caller can expect. Basically, the code specification is expressed unambiguously using a formal language that describes the code's implicit contracts. The term unit testing is used here to describe testing the smallest possible unit of an application program. For example, in terms of Java, unit testing involves testing a class as soon as it is compiled. Users can use DbC comments to filter out error messages that are not relevant to the class under test. For example, if an expected exception in the code is documented using the @exception tag, any occurrence of that particular exception may be suppressed. If a permissible range for valid method inputs using the @pre tag is documented, any errors found for inputs that do not satisfy those preconditions may be suppressed.

In one embodiment, during execution of unit tests, a test harness (e.g., FIG. 13, block 1303) repeats each unit test for a total of three or more repetitions. However, the program state is not reset or altered between unit test repetitions. The testing framework keeps a reference to the tested program module during unit test repetitions. During each unit test execution memory allocation events are recorded. Garbage collection (GC) is forced following the final unit test and memory deallocation events are recorded. Memory allocation and deallocation events are compared to identify specific unit tests that allocate memory that GC is unable to collect during each repetitive repetition. However, the code executed by such unit tests would normally leak memory during execution in the production environment.

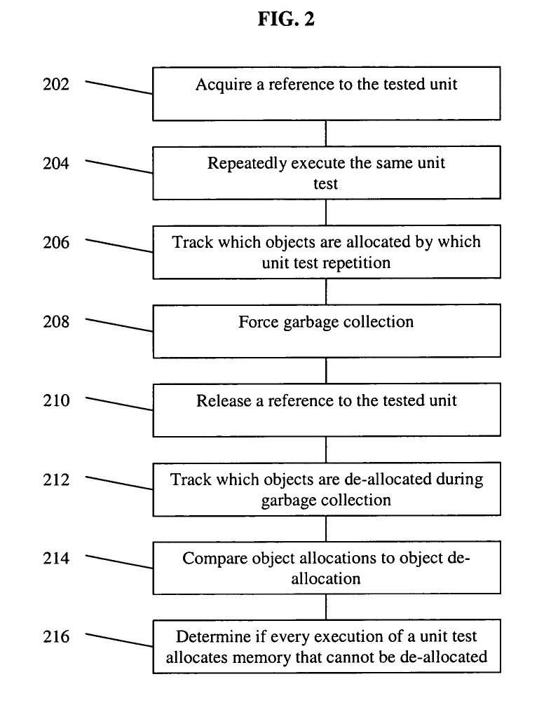

FIG. 2 is an exemplary process flow diagram, according to one embodiment of the present invention. In this embodiment, the present invention predicts whether a program unit leaks memory. As shown in block 202, the invention acquires a reference to the tested unit. This emulates the program behavior of keeping static reference to the tested unit. That, in turn, prevents static fields in the tested unit from being garbage collected.

As shown in block 204, the invention then repeatedly executes the same unit test (for example, a minimum of three times) to ensure that specific objects are allocated, as a result of calling a given tested method. The repeated execution is optional to better predict memory leak in each execution teration.

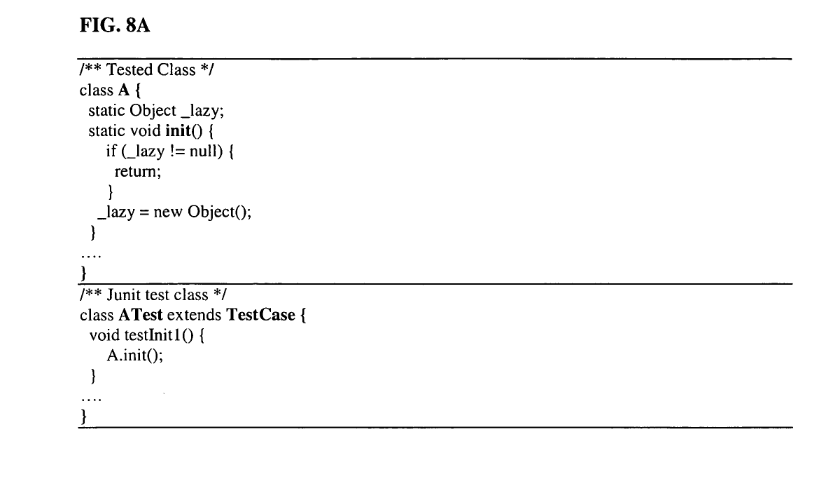

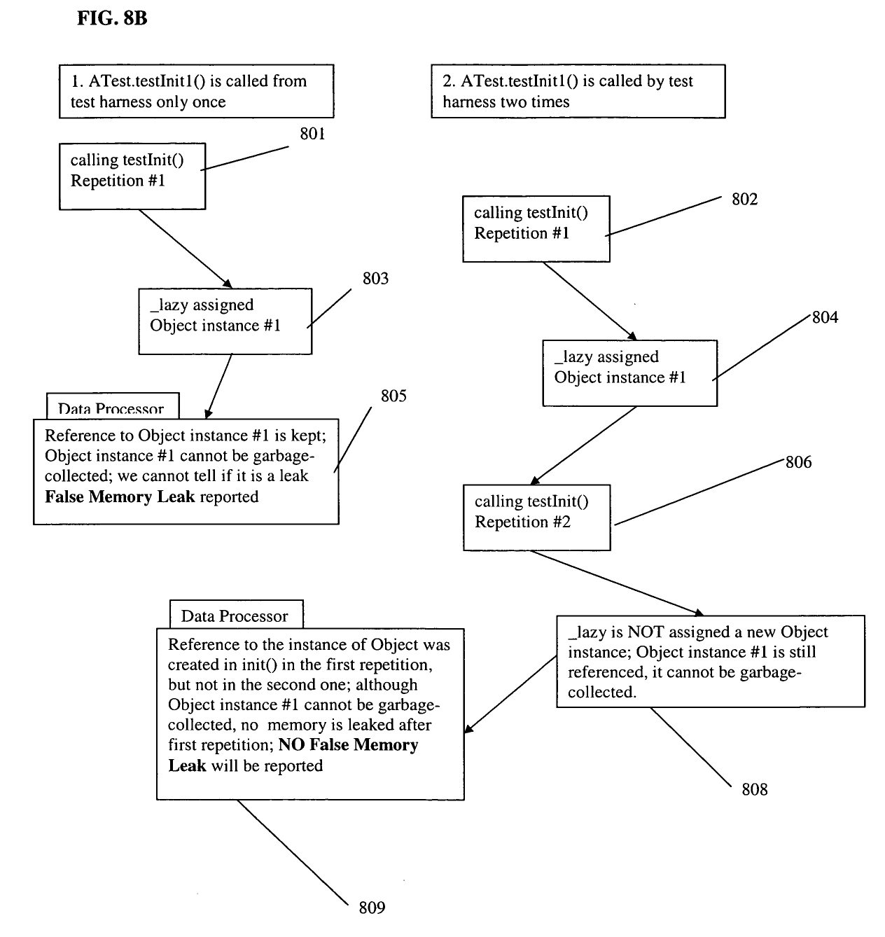

Typically, there are at least two types of memory management/optimization practices that can be misidentified as “memory leaks,” unless a test case is executed a minimum of twice and memory allocations are tracked with regards to each repetition. For example, in the “lazy initialization” pattern depicted in FIGS. 8A and 8B, calling the test method only once will always generate a false “memory leak” error because the initializer method will always assign at least one object to a static variable, as shown in FIG. 8B.

As shown in FIG. 8A, method “A.init( )” will initialize the static field “_lazy” only once, the first time it is called. No additional memory will be allocated from that method in each consequent call. Thus, the Data Analysis Module (1309 of FIG. 13) may incorrectly deem that method “A.init( )” leaked memory, unless this method is called more than once. Identification of the memory leak in this case is achieved by calling “ATest.testInit1( )” more than once.

The example in FIG. 8B describes two scenarios of leak detection in case of “lazy initialization”. In the first scenario, ATest.testInit1( ) is called from the test harness only once. In a first call to ATest.testInit1( ), A.init( ) is invoked for the first time, as shown in block 801. In block 803, “_lazy” is assigned “Object” instance # 1. In block 805, at the end of the test sequence, Data Processor analyzes memory use for A.init( ). In the first repetition, memory is allocated for type Object=X1 bytes. After garbage collection, memory allocated for type Object in the first repetition is not garbage-collected. As a result, the amount of outstanding memory increases by X1 bytes after calling A.init( ), and there may be a memory leak.

In the second scenario, ATest.testInit1( ) is called by test harness twice. A first call is made to ATest.testInit1( ), and A.init( ) is invoked for a first time, as shown in block 802. In block 804, “_lazy” is assigned “Object” instance # 1, a second call is made to ATest.testInit1( ), and A.init( ) is invoked for a second time, as shown in block 806. In block 808, “_lazy” !=null, init( ) returns right away, wile no new objects are allocated.

In block 809, at the end of the test sequence, Data Processor analyses memory use for A.init( ). In the first repetition, memory allocated for type Object is X1 bytes. In the second repetition, memory allocated for type Object is 0 bytes. After garbage collection, memory allocated for type Object in the first repetition was not garbage-collected. As a result, the amount of outstanding memory did not increase between the two repetitions, memory was only allocated in the first repetition, no memory is allocated after first repetition, no other memory is allocated, and there is no memory leak.

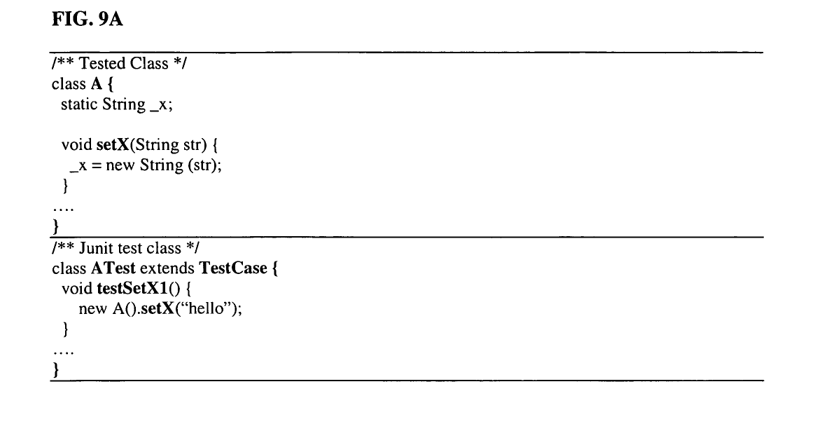

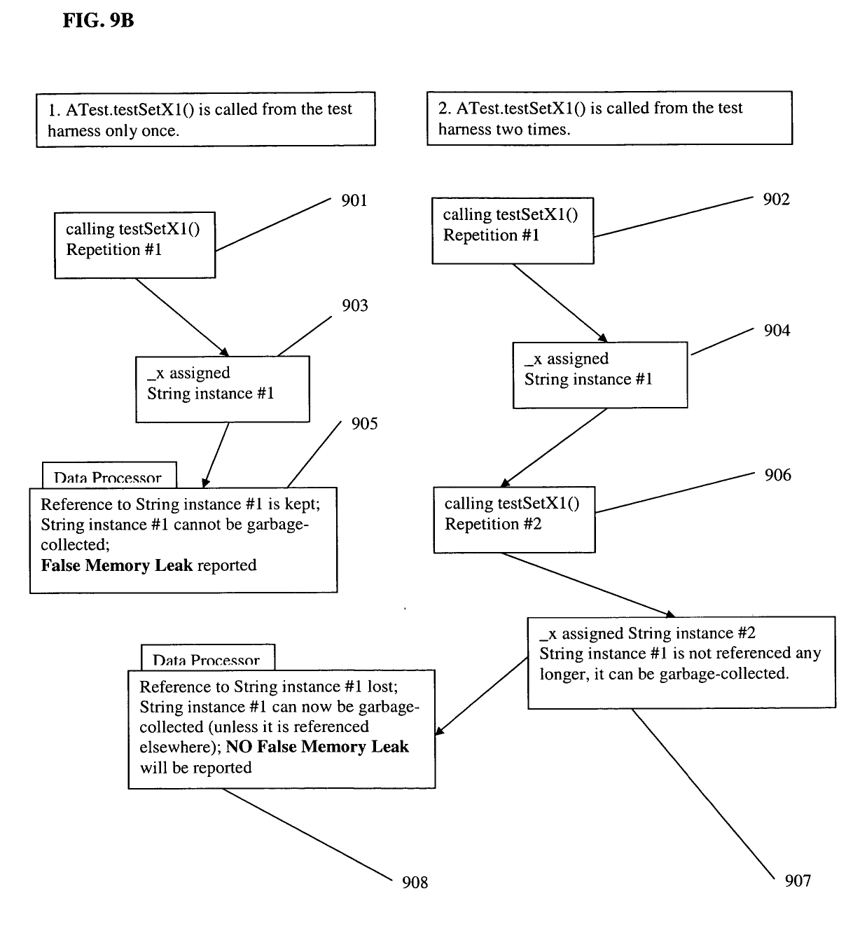

Likewise, as shown in FIG. 9A, a “storing last value” pattern will also lead to reporting the false “memory leak” error if the test case is executed only once. A “storing last value” pattern is characterized by a method caching a new object by assigning it to a static field each time it is called. For example, the method depicted in FIG. 9A. In this example, every time method setX(String str) is called, a new instance of java.lang.String object is allocated and assigned to the static field _x.

FIG. 9B describes two scenarios of leak detection in case of the “storing last value” pattern. In the first scenario, ATest.testSetX1( ) is called from the test harness only once. A first call is made to ATest.testSetX1( ), new A( ).setX(“hello”) is called for the first time, as shown in block 901 and in block 903, _x is assigned an instance #1 of the String “hello.” As shown in block 905, at the end of the test sequence, Data Processor analyzes memory use for A.setX(String str).

In the first repetition, memory allocated for type String is X1 bytes. After garbage collection, memory allocated for type String in the first repetition was not garbage-collected, and the amount of memory allocated for type String increased by X1 bytes. Therefore, the amount of outstanding memory increases after calling A.setX(String str) by X1, and there may be a memory leak.

In the second repetition, ATest.testSetX1( ) is called from the test harness twice. A first call is made to ATest.testSetX1( ), and new A( ).setX(“hello”) is called for the first time, in block 902. In block 904, _x is assigned an instance #1 of the String “hello.” A second call is made to ATest.testSetX1( ), and new A( ).setX(“hello”) is called for the second time, as shown in block 906. In block 907, _x is assigned an instance #2 of the String “hello”, and the reference to an instance #1 of the String “hello” is released. The instance #1 can now be garbage-collected.

In block 908, at the end of the test sequence, Data Processor analyzes memory use for A.setX(String str). In the first repetition, memory allocated for type String is X1 bytes, and in the second repetition, memory allocated for type String is X1 bytes. After garbage collection, all memory allocated for type String in the first repetition was garbage-collected, however, the memory allocated for type String in the second repetition was not garbage-collected. Also, the amount of memory allocated for type String in the first repetition equals to that allocated for type String in the second repetition. Consequently, the amount of outstanding memory did not increase between the two repetitions. Moreover, all memory allocated for type String in the previous repetition is marked to be garbage-collected after the following repetition, and thus no other memory is allocated, and there is no memory leak.

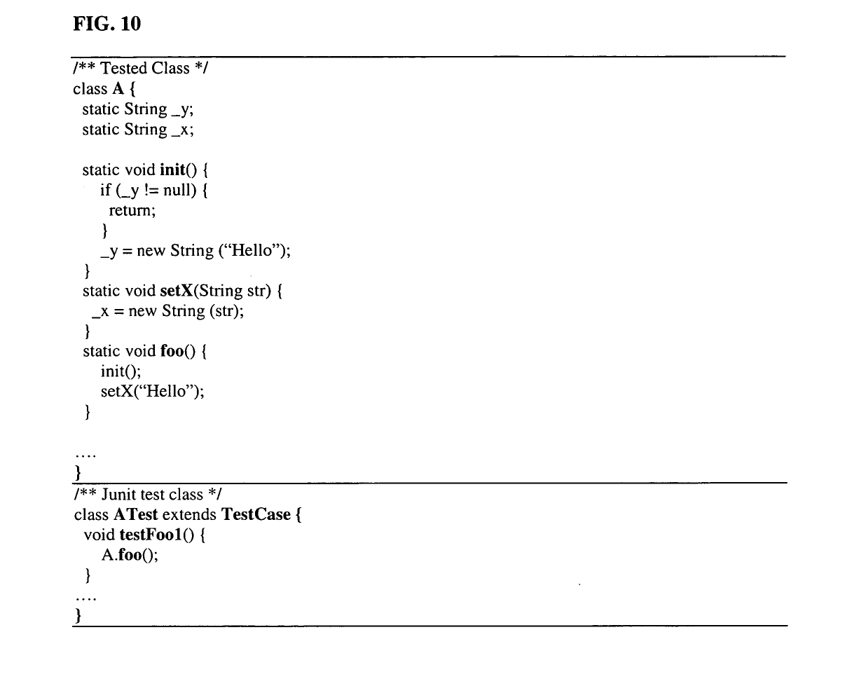

Similarly, there is at least one type of memory management/optimization practice that can be misidentified as “memory leak,” unless the test case is executed a minimum of three times or memory allocations are tracked with regards to each repetition. For example, as shown in FIG. 10, method init( ) uses a pattern of “lazy initialization”, whereas method setX(String str) uses the pattern of “storing last value”. When method A.foo( ) is invoked, both patterns come into play.

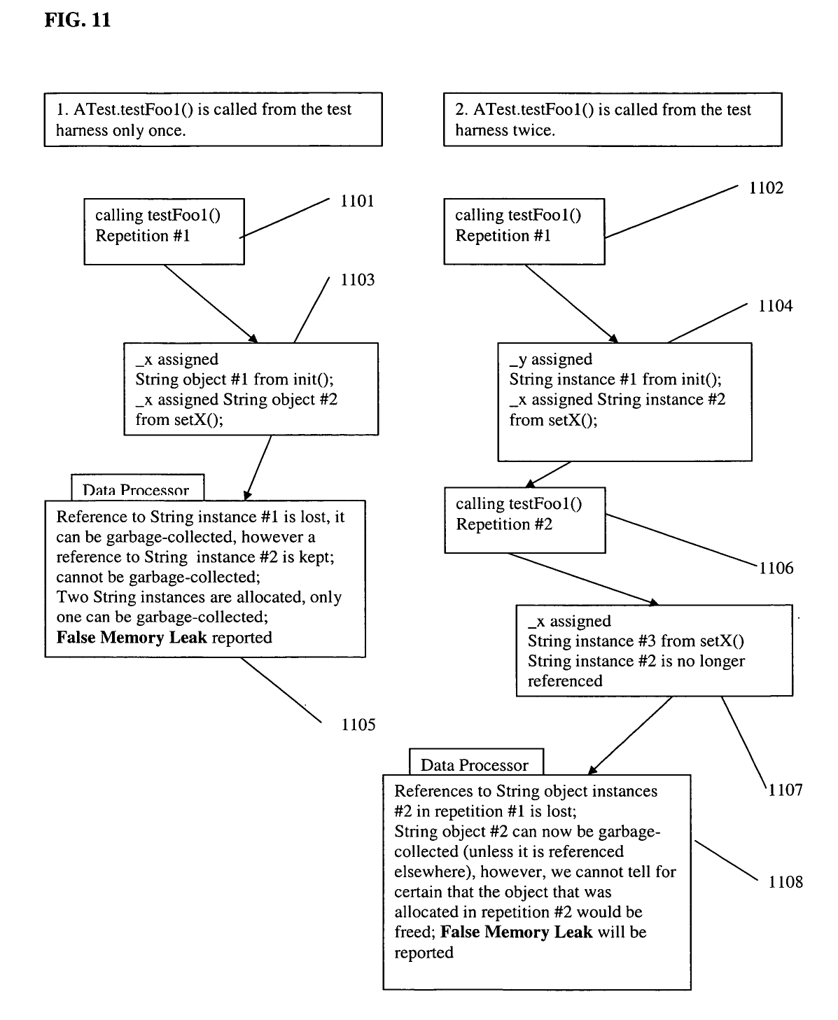

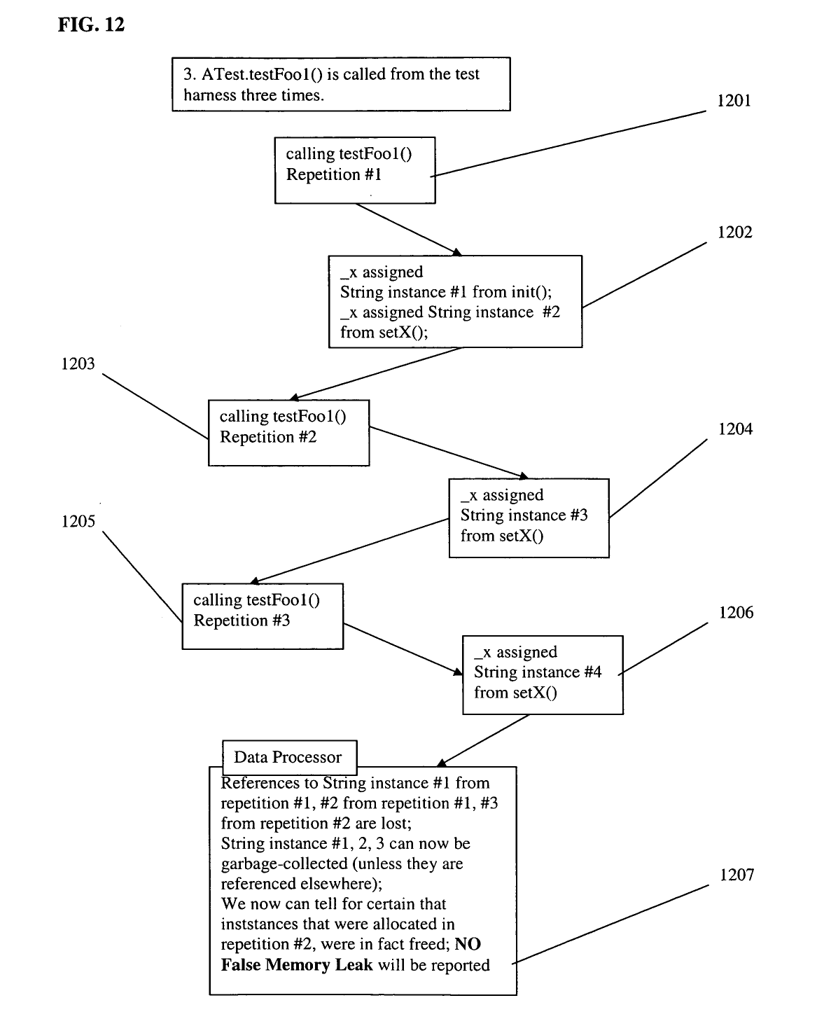

FIG. 11 illustrates two exemplary scenarios. In the first scenario, ATest.testFoo1( ) is called from the test harness only once. But, in the second scenario, ATest.testFoo1( ) is called from the test harness twice. Additionally, FIG. 12 shows a scenario when ATest.testFoo1( ) is called from the test harness three times. In the first scenario of FIG. 11, ATest.testFoo1( ) is called for the first time, as shown in block 1101. In block 1103, _x is assigned an instance of String “Hello” #1, and _y is assigned an instance of String “Hello” #2.

In block 1105, at the end of the test sequence, Data Processor analyzes memory use for A.foo( ). In the first repetition, memory allocated for type String is 2×S1 bytes. After garbage collection, memory allocated for type String in the first repetition was not garbage-collected, and the amount of memory allocated for type String increased by 2×X1 bytes. As a result, The amount of outstanding memory increases by 2×S1, after calling A.foo( ), and there may be a memory leak.

In the second scenario shown in FIG. 11, ATest.testFoo1( ) is called for the first time, in block 1102. In block, 1104 x is assigned an instance of String “Hello” #1 and _y is assigned an instance of String “Hello” #2 and ATest.testFoo1( ) is called a second time (block 1106). In block 1107, _x is assigned an instance of String “Hello” #3. Since an instance of String “Hello” #1 is no longer referenced, it is marked by the VM for garbage collection. In block 1108, at the end of the test sequence, Data Processor analyzes memory use for A.foo( ). In the first repetition, memory allocated for type String is 2×S1 bytes, and in the second repetition, memory allocated for type String is 1×S1 bytes. However, after garbage collection, the 1×S1 bytes of memory allocated for type String in the first repetition and the 1×S1 bytes of memory allocated for type String in the second repetition were not garbage-collected. As a result, the amount of outstanding memory increases by 1×S1 per repetition, after calling A.foo( ) and there may be a memory leak.

In case of third scenario shown in FIG. 12, ATest.testFoo1( ) is called for the first time, in block 1201. In block 1202, _x is assigned an instance of String “Hello” #1 and _y is assigned an instance of String “Hello” #2. ATest.testFoo1( ) is then called for a second time, as shown in block 1203. In block 1204, _x is assigned an instance of String “Hello” #3, however, an instance of String “Hello” #1 is no longer referenced and thus it is marked by the VM for garbage collection. ATest.testFoo1( ) is called third time, in block 1205. In block 1206, _x is assigned an instance of String “Hello” #4. Since, an instance of String “Hello” #3 is no longer referenced, it is also marked by the VM for garbage collection.

In block 1207, at the end of the test sequence, Data Processor analyzes memory use for A.foo( ). For the first repetition, memory allocated for type String is 2×S1 bytes. Likewise, for the second repetition, memory allocated for type String is 1×S1 bytes, and for the third repetition, memory allocated for type String is 1×S1 bytes. After garbage collection, the 1×S1 bytes of memory allocated for type String in the first repetition the 0×S1 bytes of memory allocated in for type String in the second repetition and the 1×S1 bytes of memory allocated in for type String in the third repetition are not garbage-collected. Accordingly, the amount of outstanding memory does not increase after calling A.foo( ) three times, no other memory is allocated, and there is no memory leak.

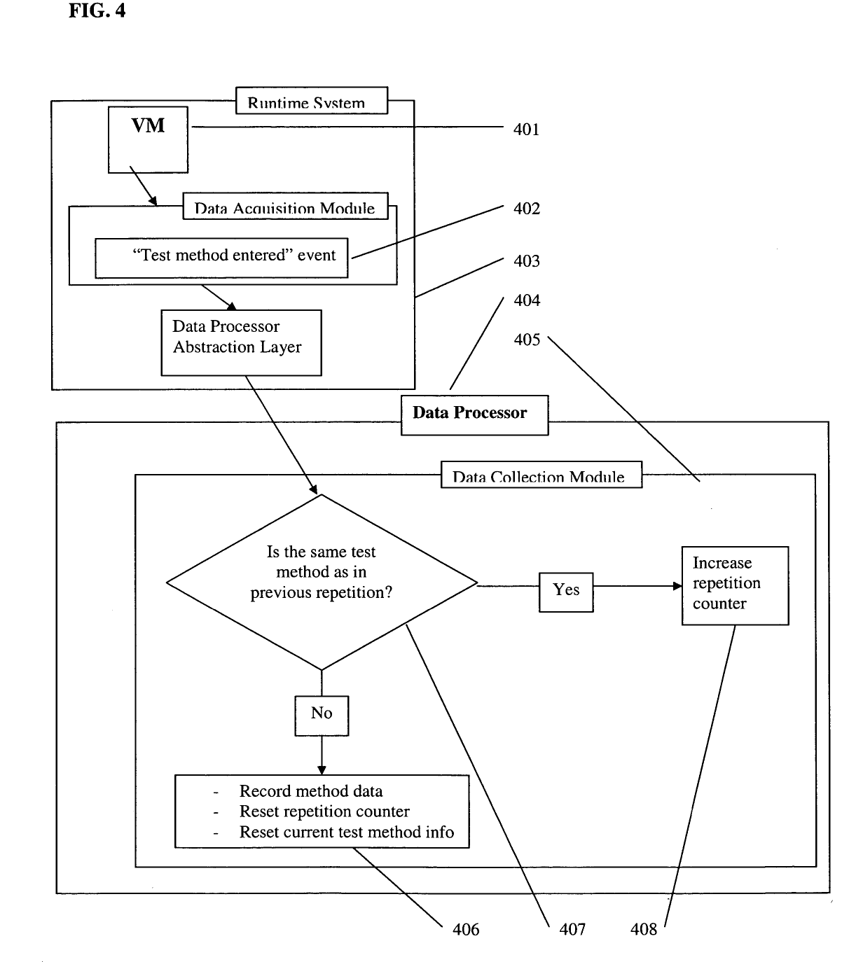

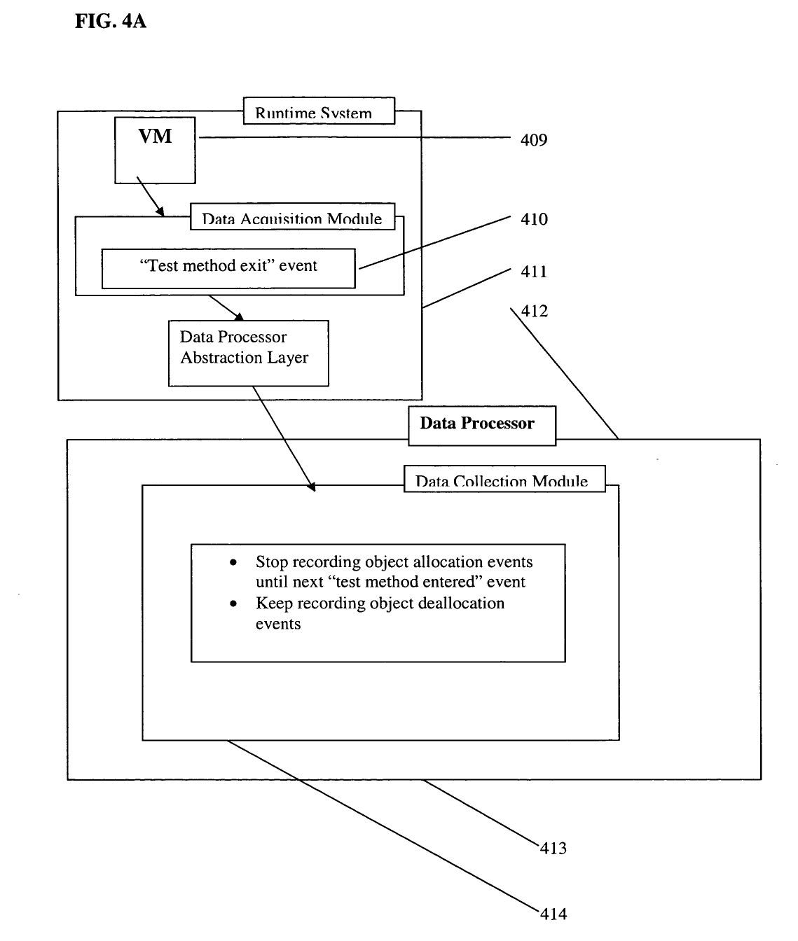

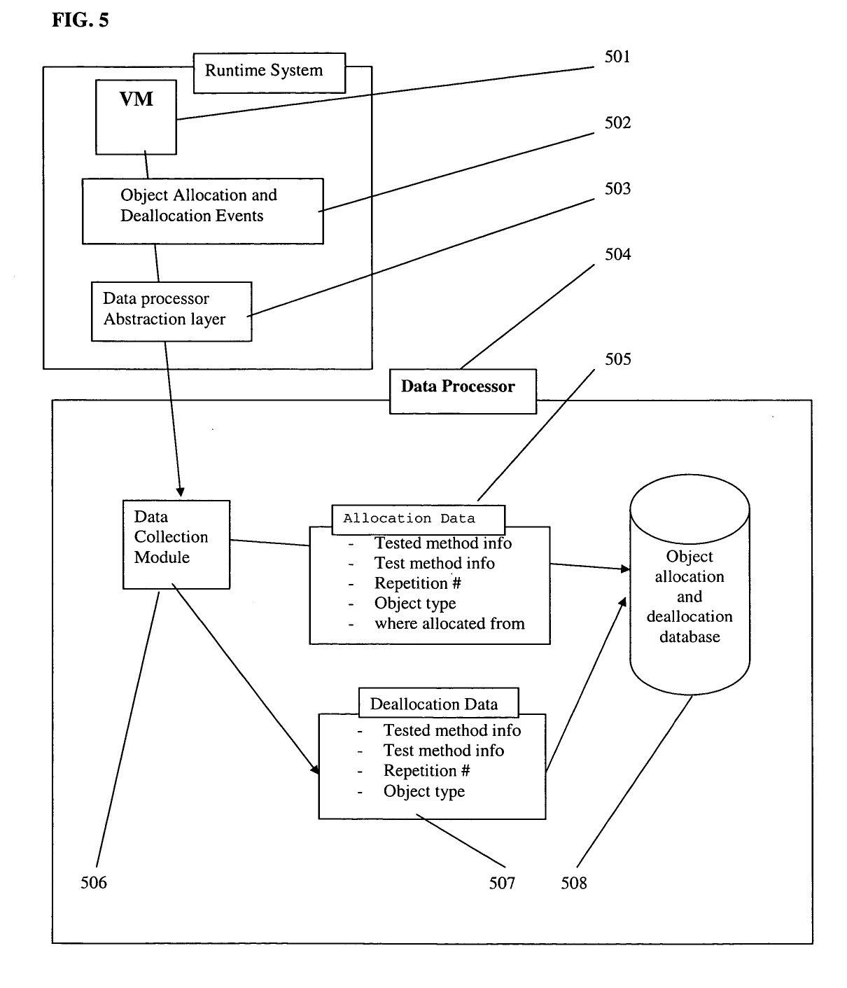

The invention then tracks which objects are allocated by which repetition, as illustrated in block 206. FIG. 4 shows how some embodiments of the invention calculate repetitions based on the “test method entered” events. FIG. 5 shows how some embodiments of the invention create “object allocation” and “object deallocation” records in its database.

As shown in FIG. 4, the Data Acquisition Module 402 enables a VM 401 to generate “method entered” events. Such events are generated when runtime environment invokes a new method. Data Acquisition Module 402 filters “method entered” events and generates “test method entered” events when “method entered” event belongs to the test method. It then reports those events to Data Processor Abstraction Layer 403. “Test method entered” events may contain information that is otherwise unavailable from the native runtime system “method entered” event. This information may be acquired by monitoring other runtime system events, or via instrumentation. An example of such information is a custom stack trace containing argument values of the methods in the stack trace associated with “method entered” event.

Data Processor Abstraction Layer 403 passes data into Data Collection Module 405 of Data Processor. Data Collection Module 405 receives “test method entered” events. In block 407, if the method is the same as in previous repetition, Data Collector Module increases repetition counter in block 408 else, Data Collector Module records method data to the database, resets repetition counter, and resets current test method info, as shown in block 406.

FIG. 4A illustrates an example for tracking object allocation and deallocation for “test method exit” event. “Test method exit event” is used by the Data Processor's (412) Data Collection Module 413 to stop recording object allocation events until next “test method entered event.” Data Acquisition Module 410 generates “Test method exit” event when “method exit” event was generated for the test method. If the host runtime system does not support method enter/exit events natively, the “test method entered/exit” events generation is achieved via instrumenting source or object code of the unit test.

FIG. 5, describes creation of object allocation and deallocation records, according to one embodiment of the invention. Runtime system 500 generates object allocation and deallocation events 502. These events include object allocation and object deallocation data. This data is passed by data processor abstraction layer 503 to data processor 504. Data collection module 506 of data processor transfers the data from the allocation and deallocation events into the database.

Allocation data record 505 includes a unique object ID, and tested method information. For example, for Java this information includes a fully qualified method name and parameter types, optionally, call trace, argument values and runtime types, return values, and runtime types. Allocation data record 505 also includes test method information, repetition number, allocated object type, and information on where the object was allocated from, such as, line number int test method, line number in tested method, method name, and allocation stack trace.

Deallocation data 507 includes a unique object ID, object type, a repetition number at which the object reference was released (optional), and an object allocation and deallocation database 508.

As shown, tested method exit event informs the Data Processor that the following object allocations are not side effects of the execution of the tested methods. Information (e.g., blocks 505, 507, in FIG. 5) for these latter allocations is not added to the object allocation and deallocation database. Object allocation events that are generated during execution of the test method are then sent to the Data Processor 402).

In one embodiment, all the objects allocated from a particular tested method have corresponding database entries in relation to: the tested method from which they were allocated; test method from which the tested method was invoked; repetition number in which they were allocated and recorded in the database; object type; object instance unique ID; and object size.

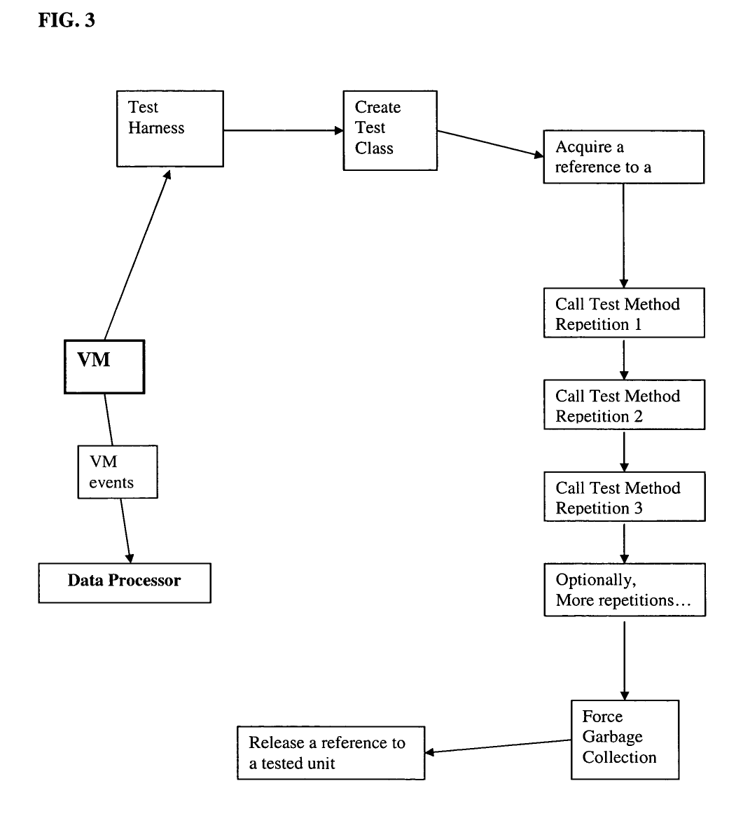

Referring back to FIG. 2, the invention performs garbage collection at the conclusion of executing the tests, as depicted in block 208 and shown in block 314 of FIG. 3. A test method exit event, after the last repetition of that test method, signifies that the garbage collection event will deallocate all the unreferenced objects allocated as a result of execution of the tested method. The Data Processor searches for database entries for deallocated objects during or after execution of a particular tested method, if the entries are found in the database (for example, using unique object Ids). A deallocation record is then added to the entry, as shown by block 414 in FIG. 4. Conversely, if a given object was not allocated as a side effect of executing tested method, the record for the object is not added to the database, and its deallocation is not relevant. In one embodiment, a deallocation record includes information on: the tested method that caused the object allocation; the test method which the tested method was invoked from; and repetition number during which the object was allocated.

In block 210, the invention releases a reference to the tested unit (also, see FIG. 3, block 316) for cleaning up before executing next test. This is an optional step for optimization. Releasing a reference helps to reduce a number of deallocation events that would need to be screened out.

For example, if type “A” is being tested (tested unit), a reference to an object of type “A” created by the test harness is released. In Java, this can be done as follows:

Object _referenceToTestedUnit = new A( ); // create a

reference

_referenceToTestedUnit = null; // release a reference.

At this point, object deallocation information is not added to the database, since the objects deallocated after the above reference was freed and before the reference to the next test object is acquired will be the suspected leaked objects.

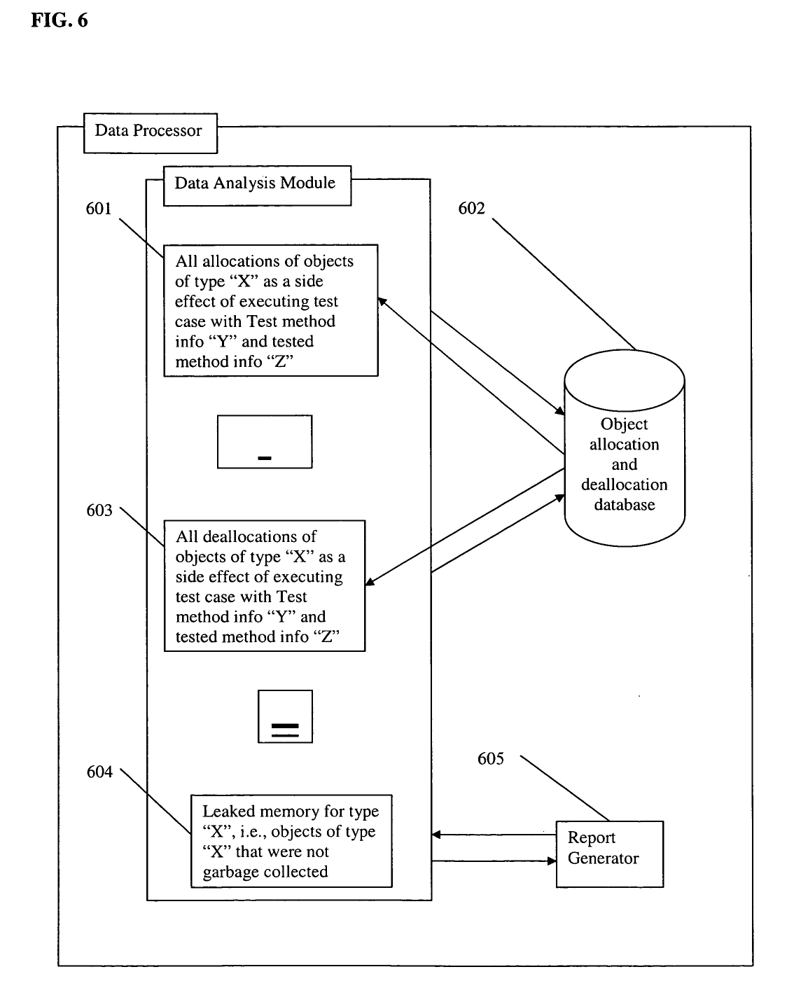

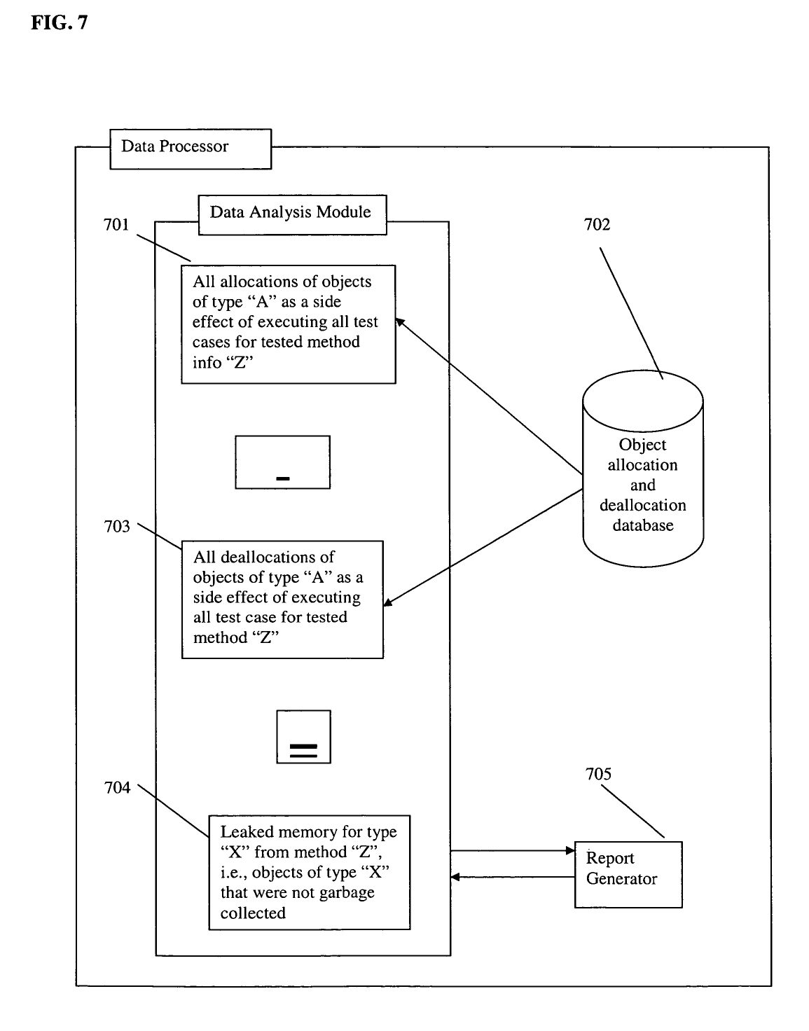

In block 212, the invention tracks which objects are deallocated during garbage collection. The objects that have deallocation record (block 505 in FIG. 5) in the database have been deallocated. Then, object allocations records are compared to object deallocations records for all allocated objects and deallocated objects, as a result of executing tested method invoked from a given test case (shown in FIG. 6). Also, the comparison is done for all objects allocated and deallocated as a result of executing a given tested method in all test cases created for it (shown in FIG. 7).

FIG. 6 illustrates an exemplary process for comparing objects allocated and deallocated as a side effect of executing a give test case, according to one embodiment of the invention. As shown, Data Analysis Module requests from the database 602, all the records for objects that were allocated as a side effect of executing test case with test method info “Y” (e.g., test method info for ATest.testFoo1( ), in FIG. 9A) and tested method info “Z” (e.g., tested method info for A.foo( ), in FIG. 9A).

In block 601, for each object allocation of type “X” within the results of the request, Data Analysis Module requests from the database information on deallocations of the objects with same object IDs as in type “X”. Deallocated objects are counted if they were deallocated as a side effect of executing test case with test method info “Y” (e.g., test method info for ATest.testFoo1( ), in FIG. 9A) and tested method with info record “Z” (e.g., tested method info for A.foo( ), in FIG. 9A), as shown in block 603.

In block 604, the difference between objects allocations and deallocations in blocks 601 and 603 is calculated and reported to a Report Generator 605 as a memory leak (unless one of the additional filtering algorithms determines that there is no leak (e.g., FIG. 8A-11).

FIG. 7 depicts an exemplary process for comparing objects allocated and deallocated as a side effect of executing a given tested method in all test cases created for that test method, according to one embodiment of the invention. As shown, Data Analysis Module computes memory leaks as a difference between all memory allocations and deallocations as a result of executing a particular tested method without regard to the test method from which it was invoked from. For this purpose, Data Analysis Module requests from the database 702 all the records for objects that were allocated as a result of executing tested method with information “Z” (e.g., tested method information for “A.foo( )”, in FIG. 9A).

For each object allocation of each data type, for example data type “A”, in the data requested above (block 701), Data Analysis Module requests from the database deallocation information (block 703). Deallocated objects are counted in, if they were deallocated, as a result of executing tested method with info record “Z” (e.g., tested method info for A.foo( ), FIG. 9A), as shown in block 703. In block 704, the difference between objects allocations and deallocations in blocks 701 and 703 is calculated and reported to Report Generator 705 as a memory leak (unless one of the additional filtering algorithms determines that there is no leak (FIG. 8A-11). The invention then determines if every execution of a unit test allocates some amount of memory that cannot be deallocated. If the above comparison shows outstanding allocations, suspected leaks are identified and reported (FIGS. 6 and 7).

In one embodiment, the invention tracks object deallocations when garbage collection has not been explicitly requested. The garbage collection can be performed at any point, because the deallocation events (related to the test and tested method information) are stored in the database continuously, as soon as the VM reports that it has entered tested method.

In one embodiment, the invention computes metrics on the allocated and deallocated memory, based on database entries for memory allocation/deallocations, as shown in FIG. 5. Total memory leak is computed as the sum of all leaks per program unit for leaks size per all tested code, leaks size per project, leaks size per tested program unit, and leaks size per tested method. Each memory leak figure mentioned above can be broken down to types of objects leaked: leak size, and leak origin (tested methods). The invention then sums all memory allocations from a given program unit and memory deallocations from the same unit.

In one embodiment, the invention computes gross memory leaks as a difference between all the memory allocated and deallocated, while executing the tested method. The amount of allocated memory is computed as the sum of all allocated memory for that type of metric. The amount of deallocated memory is computed as the sum of all deallocated memory for that type of metric.

The invention is also capable of computing information derived from database. For instance, the sum of the number of all the objects allocated as a result of executing a given program unit and the sum of the number of all the objects leaked can be obtained when executing the program unit, as shown in FIG. 5.

In one embodiment, the invention tracks the class of each object by adding type information for each memory allocation database entry, as shown in FIG. 5, blocks 505. The invention is also capable of tracking the context of the executing program during memory allocation for each allocated object as a result of storing tested method record to the database. For example, tested method's arguments values, tested method's return values, and/or the stack trace to the place where memory allocation occurred, are tracked.

The invention is also capable of tracking the function, the method, or the subroutine being executed. For example, for every method invoked when the tested method is being executed, the method's arguments values and return value(s), and the position of the method in the stack trace that lead to a given memory allocation can be tracked. Also, functions, methods, and/or subroutines that are filtered according to a specified filter can be tracked. For instance, the invention is capable of tracking methods only if they are filtered in, or not filtered out.

In one embodiment, the invention tracks the line of source code being executed by enabling line execution events, and adding this information to “Allocation Data” in the corresponding database entry for memory allocation, as shown in FIG. 5. The invention is also capable of tracking the line of source code according to a filter, that is, tracking allocation/deallocation information resulting from executing a specified line of code.

In one embodiment, the invention tracks the call stack during memory allocation and records the call stack that leads to a memory allocation in the database. The invention also tracks the call stack with line number information.

In one embodiment, the testing framework of the invention prevents static data objects from being deallocated by keeping a reference to the tested unit, as shown in FIG. 3. The testing framework does not explicitly prevent any dynamic data object from being deallocated, that is, the testing framework clears all the references it might have to the tested unit.

It will be recognized by those skilled in the art that various modifications may be made to the illustrated and other embodiments of the invention described above, without departing from the broad inventive scope thereof. It will be understood therefore that the invention is not limited to the particular embodiments or arrangements disclosed, but is rather intended to cover any changes, adaptations or modifications which are within the scope of the appended claims. For example, although the present invention is described in conjunction with Java, any other language that supports automatic garbage collection can be unit tested and its memory leaks predicted using the present invention.

What is claimed is:

1. A method for predicting memory leak in a computer program, the method comprising:
acquiring a reference to a tested unit included in the computer program for preventing static data objects from being deallocated;
repeatedly executing the tested unit for more than once;
tracking which objects in the tested unit are allocated;
performing garbage collection;
tracking which objects are deallocated during the garbage collection;
comparing the object allocations to the object deallocations; and
determining if every execution of the tested unit allocates memory that cannot be deallocated.

2. The method of claim 1 further comprising reporting the object allocations that cannot be deallocated, as memory leaks.

3. The method of claim 1 further comprising computing metrics on the object allocations and the object deallocations.

4. The method of claim 3 wherein the metrics include one or more of the group consisting of leaks per program unit, leaks per all tested code, leaks per project, leaks per tested program unit, and leaks per tested method.

5. The method of claim 1 further comprising computing a total memory leak for the computer program as a difference between the object allocations and the object deallocations for all tested units of the computer program.

6. The method of claim 1 further comprising tracking a class of each object for each tested unit of the computer program.

7. The method of claim 1 further comprising releasing a reference to the tested unit.

8. The method of claim 6 further comprising tracking functions, methods, and subroutines of the computer program for memory allocations.

9. The method of claim 8 further comprising recording, for every method invoked in the computer program, one or more of argument values of the method, return values of the method, position of the method in a stack trace that leads to a given memory allocation, and a thread in which the method runs.

10. The method of claim 8 wherein the tracking is performed according to a filter.

11. The method of claim 1 further comprising tracking lines of a source code of the computer program.

12. The method of claim 11 wherein the tracking is performed according to a filter.

13. The method of claim 1 further comprising tracking a call stack during object allocation.

14. The method of claim 1 further comprising tracking context of the computer program during object allocation.

15. A system for predicting memory leak in a computer program comprising:
means for acquiring a reference to a tested unit included in the computer program for preventing static data objects from being deallocated;
means for repeatedly executing the tested unit for more than once;
means for tracking which objects in the tested unit are allocated in a corresponding executing time;
means for performing garbage collection;
means for tracking which objects are deallocated during the garbage collection;
means for comparing the object allocations to the object deallocations; and
means for determining if every execution of the tested unit allocates memory that cannot be deallocated.

16. The system of claim 15 further comprising means for reporting the object allocations that cannot be deallocated, as memory leaks.

17. The system of claim 15 further comprising means for computing metrics on the object allocations and the object deallocations.

18. The system of claim 17 wherein the metrics include one or more of the group consisting of leaks per program unit, leaks per all tested code, leaks per project, leaks per tested program unit, and leaks per tested system.

19. The system of claim 15 further comprising means for computing a total memory leak for the computer program as a difference between the object allocations and the object deallocations for all tested units of the computer program.

20. The system of claim 15 further comprising means for tracking a class of each object for each tested unit of the computer program.

21. The system of claim 15 further comprising means for releasing a reference to the tested unit.
